(19) United States
(12) Patent Application Publication
(10) Pub. No.: US 2026/0169742 A1
(43) Pub. Date: Jun. 18, 2026

(54) APPARATUS AND METHOD FOR PROCESSING MULTIPLE OPERATIONS BY USING INSTRUCTION DECODER AND OPERATOR

(71) Applicant: Electronics and Telecommunications Research Institute, Daejeon (KR)

(72) Inventor: Won JEON, Daejeon (KR)

(73) Assignee: Electronics and Telecommunications Research Institute, Daejeon (KR)

(21) Appl. No.: 19/421,074

(22) Filed: Dec. 16, 2025

(30) Foreign Application Priority Data
Dec. 17, 2024 (KR) 10-2024-0188128
Mar. 26, 2025 (KR) 10-2025-0038728

(51) Int. Cl. G06F 9/30

(52) U.S. Cl. CPC G06F 9/3016; G06F 9/30065

(57) ABSTRACT

An aspect of the present disclosure provides an apparatus for processing multiple operations, the apparatus comprising: an instruction decoder configured to generate one or more second instructions by using a first instruction comprising a first field containing information on the multiple operations and one or more second fields distinct from the first field; and an operator configured to process the multiple operations based on data stored in a register file and the one or more second instructions, wherein the multiple operations are performed based on a single instruction.

### CROSS-REFERENCE TO RELATED APPLICATION

The present application claims priority to Korean Patent Application No. 10-2024-0188128, filed on Dec. 17, 2024 and Korean Patent Application No. 10-2025-0038728, filed on Mar. 26, 2025 in the Korea Intellectual Property Office, the entire contents of which are incorporated herein by reference.

### TECHNICAL FIELD

The present disclosure relates to an apparatus and method for processing multiple operations by using instruction decoder and operator.

### BACKGROUND

The statements in this section merely provide background information related to the present disclosure and do not necessarily constitute prior art.

Artificial intelligence processors are being developed to efficiently process multiple operations. Accordingly, technology for determining an instruction set architecture (ISA) that controls the operation of the processor is becoming increasingly important.

Unlike conventional general-purpose CPUs or GPUs, artificial intelligence processors iteratively perform the same operations on large amounts of data such as vectors and matrices, rather than performing complex operations on each individual piece of data by a user. When performing this type of operation, a method in which a single instruction supports multiple complex operations is referred to as CISC (complex instruction set computer).

While conventional technologies related to CISC-type artificial intelligence processor instructions were able to improve instruction usage efficiency, since the amount of artificial neural network operations is gradually increasing, a large number of instructions are required to perform the target operation.

Therefore, when performing repetitive artificial neural network operations, problems arise in that excessive on-chip memory capacity is required for instruction storage, more resources are consumed in fetching and decoding a large number of instructions, and the performance of the operator deteriorates.

### SUMMARY

An object of the disclosure is to provide an apparatus and method for processing large-scale artificial neural network operations requiring thousands to tens of thousands of cycles with a single instruction.

The technical objects of the present disclosure are not limited to those described above, and other technical objects not mentioned above may be understood clearly by those skilled in the art from the descriptions given below.

An embodiment of the present disclosure provides an apparatus for processing multiple operations, the apparatus comprising: an instruction decoder configured to generate one or more second instructions by using a first instruction comprising a first field containing information on the multiple operations and one or more second fields distinct from the first field; and an operator configured to process the multiple operations based on data stored in a register file and the one or more second instructions, wherein the multiple operations are performed based on a single instruction.

Another embodiment of the present disclosure provides a method for processing multiple operations performed by an apparatus comprising an instruction decoder and an operator, the method comprising: generating, by the instruction decoder, one or more second instruction by using a first instruction comprising a first field containing information on the multiple operations and one or more second fields distinct from the first field; and performing, by the operator, the multiple operations based on data stored in a register file and the one or more second instructions.

According to an embodiment of the disclosure, there is an effect of significantly expanding the size of operations controllable by a single instruction in operations performed by artificial intelligence applications.

In addition, there is an effect of applying a flexible design depending on the operation capability of the operator and the size of the instruction in designing artificial intelligence processors, and preventing problems that occur when the size of the register file is smaller than operand data when simply supporting loop functions.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a diagram schematically showing a configuration of a system for performing multiple operations with a single instruction according to an embodiment of the disclosure.

FIG. 2 is a block diagram showing an example of a structure of a first instruction and a second instruction according to an embodiment of the disclosure.

FIG. 3 is a flowchart of a method of multiple operations of a system according to an embodiment of the disclosure.

FIG. 4 is a sequence diagram showing a flow of data in an apparatus according to an embodiment of the disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

This embodiment may employ an instruction decoding and execution method of a complex instruction set computer (CISC) type, in which an operation in which a plurality of operations are intricately mixed, such as multiplication between matrices, may be processed by a single instruction.

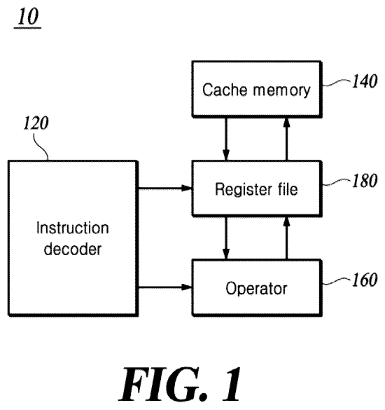

FIG. 1 is a diagram schematically showing a configuration of a system for performing multiple operations with a single instruction according to an embodiment of the disclosure.

Referring to FIG. 1, the apparatus for processing multiple operations 10 according to the disclosure may include an instruction decoder 120, a cache memory 140, a register file 180, and an operator 160.

The instruction decoder 120 is an apparatus configured to interpret machine language instructions and convert them into control signals for execution by the CPU. The instruction decoder 120 may include an instruction register (IR), an operation code (OPCODE) decoder, an operator and operand extractor, and a control signal generator.

The instruction decoder 120 may read out a first instruction. The instruction decoder 120 may interpret information of the first instruction to determine required registers and operation methods. The instruction decoder 120 interprets the information of the first instruction to generate one or more second instructions. The instruction decoder 120 may transmit the generated second instructions to the register file 180 and the operator 160. The instruction decoder 120 may perform a function of deleting operand data from the register file 180, wherein the operand data are results of operations already performed during execution of iterative operations.

The instruction decoder 120 may divide input data into a size of data processable at once by the operator 160 when the size of the input data exceeds the size of data processable at once by the operator 160. When divided, the instruction decoder 120 may update the second instruction to have a register address of the divided operand data.

The cache memory 140 stores data required for operations of the register file 180.

The register file 180 may read out data required for operations from the cache memory 140 based on one or more second instructions received from the instruction decoder 120. The cache memory 140 may send data required for multiple operations to the register file 180. The register file 180 may transmit data required for operations to the operator 160 according to the second instructions received by the instruction decoder 120.

The operator 160 processes operations based on the data stored in the register file 180 and the second instruction transmitted by the instruction decoder 120. The operator 160 may be configured to perform various operation tasks according to the second instruction. The operator 160 may have a special-purpose operator structure specialized for multiple operations. The operator 160 may be an artificial intelligence-based operator.

The operator 160 may perform parallel operations on data. For example, the operator 160 may perform parallel operations on large amounts of data, such as performing vector-to-vector parallel operations or performing matrix multiplication operations of matrix-to-matrix. The operator 160 may iteratively perform unit operations for multiple operations.

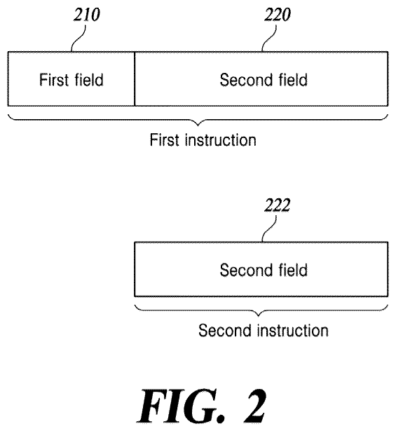

FIG. 2 is a block diagram showing an example of a structure of a first instruction and a second instruction according to an embodiment of the disclosure.

The first instruction is a single instruction. The first instruction may include information for using the operator and information for performing multiple operations. The first instruction may include one or more fields. The first instruction may include a first field 210 and a second field 220. The first field 210 of the first instruction may include loop information that defines iterative operations for performing multiple operations. The loop information may contain the total size of an operand matrix or operand vector to be processed by the multiple operations.

In an embodiment of the first field 210, when performing multiplication of matrices [32*8192]*[8192*32] to calculate a result matrix of [32*32], values (M, N, K) representing the sizes of matrices, such as 32, 8192, and 32, may be specified in the first field 210.

The second field 220 may include at least one of a register address and an operation type, excluding the loop information of the first field 210. The second instruction may be an instruction updated by the instruction decoder 120 such that a register address field among the second field 220 of the first instruction has a register address of operand data to be processed by the operator 160. The second instruction may be composed of fields excluding the first field 210 among the first instruction. That is, the second instruction may be composed of a second field 222 having updated information of the second field 220 in the first instruction.

The second field 222 of the second instruction may have an updated register address of operand data to be processed by the operator 160. The second field 222 may include at least one of a register address and an operation type for use by the operator 160.

The second instruction may be transmitted to the register file 180 and the operator 160 by the instruction decoder 120. The second instruction may include information on unit operations and operation types that the operator 160 has to iteratively perform for the multiple operations. The second instruction may be iteratively generated by the instruction decoder 120. In an embodiment, the instruction decoder 120 interprets information on the multiple operations of the first field 210 of the first instruction. When, as a result of interpreting the information on the multiple operations by the instruction decoder 120, a size of data to be operated exceeds the size of operand data processable at once by the operator 160, the instruction decoder 120 may generate the second instruction as many times as necessary.

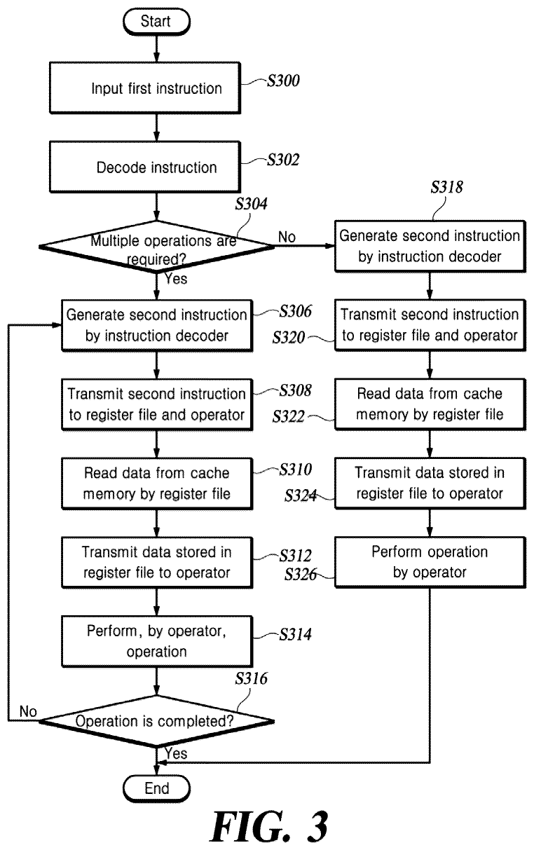

FIG. 3 is a flowchart of a method of multiple operations of a system according to an embodiment of the disclosure.

A first instruction including the first field 210 containing multiple operation information and one or more second fields 220 distinct from the first field is input to the instruction decoder 40 (S300).

The instruction decoder 120 reads the loop information contained in the first field 210 of the first instruction (S302).

The instruction decoder 120 determines whether multiple operations are required based on the loop information (S304). When the instruction decoder 120 determines that multiple operations are required (S304—YES), the instruction decoder 120 may generate a second instruction (S306). If the instruction decoder 120 determines that multiple operations are not required (S304—NO), the instruction decoder 120 may generate a second instruction (S318).

In an embodiment, when the size of input data to be processed by the operator 160 exceeds the size of data processable at once by the operator 160, the instruction decoder 120 may divide the input data into units of size of data processable at once by the operator 160, and generate a second instruction having a new register address corresponding to each divided operand data (S306).

For example, in a matrix multiplication of [32*8192]*[8192*32], in order to calculate one result value of the result matrix [32*32], vectors of [1*8192]*[8192*1] need to be multiplied and added together. While conventional artificial intelligence operators could not calculate data of this size at once, according to the disclosure, the instruction decoder 120 may divide the input data into units of data processable at once by the operator 160 and iteratively generate the second instruction as many times as necessary.

When the instruction decoder 120 determines that multiple operations are required based on the information contained in the first field 210 (S304—YES), the instruction decoder 120 may iteratively generate a new second instruction as many times as necessary by updating the register address among the information contained in the second field 220 (S306).

After generating the second instruction, the instruction decoder 120 may transmit the second instruction to the register file 180 and the operator 160 (S308).

When the instruction decoder 120 generates the second instruction multiple times, the instruction decoder 120 may transmit the second instruction to the register file 180 and the operator 160 whenever the second instruction is newly generated.

The register file 180 may read out data required for the operation from the cache memory 140 according to the received second instruction (S310).

The register file 180 transmit data required for the operation read out from the cache memory 140 to the operator 160 (S312).

The operator 160 may perform parallel operations using information such as operation and operation types contained in the second instruction received from the instruction decoder 120 and operand data received from the register file 180 (S314).

When the instruction decoder 120 determines that multiple operations are not required (S304—NO), the processes of S318, S320, S322, S324, and S326 may proceed sequentially, and each process may be identical to S306, S308, S310, S312, and S314.

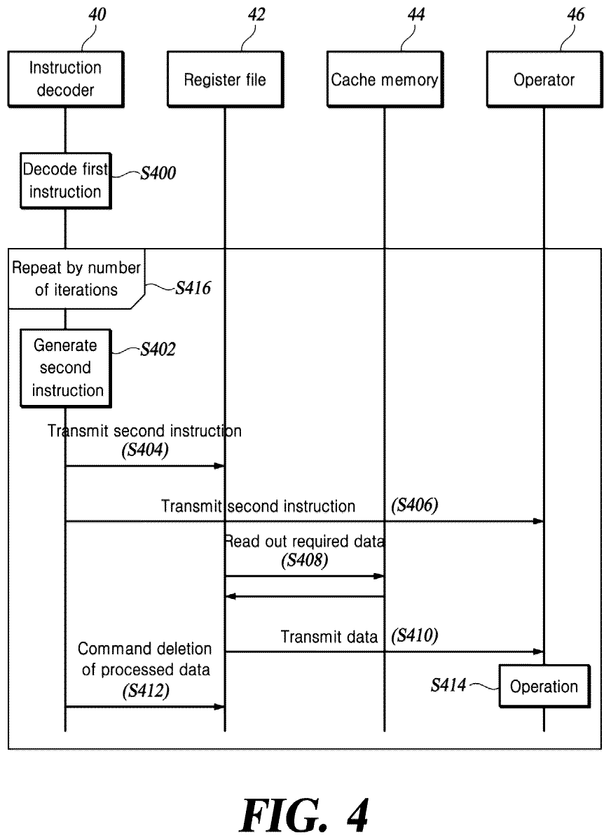

FIG. 4 is a sequence diagram showing a flow of data in an apparatus according to an embodiment of the disclosure.

The apparatus according to one embodiment of the disclosure may include an instruction decoder 40, a register file 42, a cache memory 44, and an operator 46.

The instruction decoder 40 may read out the first instruction and determine the number of times to generate the second instruction according to the multiple operation information in the first field 210. The process of S416 may be repeated according to the number of times to generate the second instruction (S400).

The instruction decoder 40 generates a second instruction (S402).

The second instruction is transmitted from the instruction decoder 40 to the register file 42 (S404).

The second instruction is transmitted from the instruction decoder 40 to the operator 46 (S406).

The register file 42 may read out data required for the operation from the cache memory 44 according to the second instruction (S408).

The operand data is transferred from the register file 42 to the operator 46 (S410).

The instruction decoder 40 may have a control function of continuously deleting data from the operator 46 while performing iterative operations. Here, the deleted data may be data that no longer required to be stored in the register file 42 since all required operations have already been performed. For example, the instruction decoder 40 may send a delete command to delete data for which unit operations have been completed by the operator 46, from the register file 42 (S412).

The operand data transmitted from the register file 42 to the operator 46 may be used for operations by the operator 46 according to instructions received from the second instruction (S414).

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. An apparatus for processing multiple operations, the apparatus comprising:
an instruction decoder configured to generate one or more second instructions by using a first instruction comprising a first field containing information on the multiple operations and one or more second fields distinct from the first field; and
an operator configured to process the multiple operations based on data stored in a register file and the one or more second instructions,
wherein the multiple operations are performed based on a single instruction.

2. The apparatus of claim 1, wherein
the first field contains loop information indicating repetitive operations for the multiple operations.

3. The apparatus of claim 2, wherein
the loop information contains a size of an entire matrix or an entire vector to be processed by the multiple operations.

4. The apparatus of claim 1, wherein
the second field comprises at least one of a register address of operand data for performing the multiple operations and an operation type.

5. The apparatus of claim 1, wherein
the second instruction is configured with fields excluding the first field from the configuration of the first instruction, a register address field among the one or more second fields being updated to have a register address of operand data to be processed by the operator.

6. The apparatus of claim 1, wherein
the operator performs parallel operations on data.

7. The apparatus of claim 1, wherein
the second instruction indicates a unit operation iteratively performed by the operator for the multiple operations and a type of operation required for the operation.

8. The apparatus of claim 1, wherein
the instruction decoder, when it is determined that a size of input data to be processed by the operator exceeds a size of data processable at once by the operator, divides the input data into units of the size of data processable by the operator at once and provides the second instruction corresponding to each divided operand data.

9. The apparatus of claim 8, wherein
the instruction decoder transmits the second instruction updated to have a register address of the divided operand data, to the register file and the operator.

10. The apparatus of claim 1, wherein
the instruction decoder deletes data, among data stored in the register file, in which a unit operation is completed by the operator.

11. The apparatus of claim 1, further comprising:
a register file configured to read data required for a unit operation from a cache memory based on the one or more second instructions received from the instruction decoder, and transmit the data required for the unit operation to the operator.

12. A method for processing multiple operations performed by an apparatus comprising an instruction decoder and an operator, the method comprising:
generating, by the instruction decoder, one or more second instruction by using a first instruction comprising a first field containing information on the multiple operations and one or more second fields distinct from the first field; and
performing, by the operator, the multiple operations based on data stored in a register file and the one or more second instructions.

13. The method of claim 12, wherein the generating one or more second instruction comprises:
removing, by the instruction decoder, the first field from the first instruction, and updating a register address field of the second instruction among the second fields to have a register address of target operand data, thereby generating the second instruction.

14. The method of claim 12, wherein
the second instruction indicates a unit operation to be iteratively performed by the operator for the multiple operations and a type of operation required for the operation.

15. The method of claim 12, wherein
the operator performs parallel operations on data.

16. The method of claim 12, further comprising:
reading, by the register, data required for a unit operation from a cache memory based on the one or more second instructions transmitted from the instruction decoder; and
transmitting, by the register, the data required for the unit operation to the operator.

17. The method of claim 12, further comprising:
deleting, by the instruction decoder, data among the data stored in the register file, the data being completed for unit operation by the operator.

18. The method of claim 12, wherein the generating one or more second instruction comprises:
when the instruction decoder determines that multiple operations are required based on the first instruction, iteratively generating new second instructions having different register addresses through updating.

19. The method of claim 18, wherein iteratively generating new second instructions comprises:
when it is determined that a size of input data processed by the operator exceeds a size of data processable at once by the operator, dividing the input data into units of the size of data processable at once by the operator, and generating the second instructions corresponding to each divided operand data.

20. The method of claim 18, wherein iteratively generating new second instructions comprises:
updating, by the instruction decoder, the second instructions so as to have new register addresses of operand data divided to be processed at once by the operator, and transmitting the second instructions to the register file and the operator.
